(19) United States
(12) Patent Application Publication
(10) Pub. No.: US 2026/0328149 A1
(43) Pub. Date: Oct. 22, 2026

(54) GREEN HOUSE GAS (GHG) EMISSION REDUCTION IN DUAL FUEL METHANOL MARINE ENGINE USING CARBON NEUTRAL FUELS BASED ON METHANOL REFORMING TO IGNITION PROMOTERS

(71) Applicant: SAUDI ARABIAN OIL COMPANY, Dhahran (SA)

(72) Inventors: Vallinayagam Raman, Dhahran (SA); Junseok Chang, Dhahran (SA); Jaeheon Sim, Dhahran (SA)

(73) Assignee: SAUDI ARABIAN OIL COMPANY, Dhahran (SA)

(21) Appl. No.: 19/180,466

(22) Filed: Apr. 16, 2025

(51) Int. Cl. F02D 19/06; F02B 43/12; F02D 19/08

(52) U.S. Cl. CPC F02D 19/0615; F02B 43/12; F02D 19/0694; F02D 19/08

(57) ABSTRACT

A system includes dual fuel injector disposed centrally on a cylinder has a first set of one or more nozzles for injecting a methanol stream and a second set of one or more nozzles for injecting a second fuel. The spark plug is disposed adjacent to the dual fuel injector and in the fluid communication with the main combustion chamber. The methanol tank is fluidly connected to a first set of one or more orifices of the dual fuel injector. The second fuel tank is fluidly connected to a second set of one or more orifices of the dual fuel injector. A first methanol stream is fed to a dual fuel injector. A second methanol stream is reformed in an onboard methanol reformer, producing a reformer effluent stream. The first fuel and the second fuel are combusted in a main combustion chamber of the methanol-fueled engine.

### BACKGROUND

The Marine Environmental Protection Committee (MEPC) has recently revised the Green House Gas (GHG) strategy with the aim of zero GHG emissions by 2050. Eliminating the use of fossil fuels is crucial to transition towards low carbon or zero-carbon fuels. For example, methanol is a potential candidate because methanol can significantly reduce carbon emissions compared to traditional fossil fuels. Furthermore, methanol can be stored and transported easily. However, the use of a dual fuel injector to inject methanol as main fuel and other fuels as pilot fuel through the same nozzle has challenged many marine engine manufacturers. As a result, marine engine manufacturers strive towards the development of methanol fueled marine engines with the development of the dual fuel injector. Accordingly, a methanol marine engine design with a dual fuel injector that can inject two different fuels through the same nozzle is desirable.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A system includes a dual fuel injector, a spark plug, a methanol tank, and a second fuel tank. The dual fuel injector is disposed centrally on a cylinder head and in fluid communication with a main combustion chamber of a marine engine. The dual fuel injector has a first set of one or more nozzles for injecting a methanol stream and a second set of one or more nozzles for injecting a second fuel. The spark plug is disposed adjacent to the dual fuel injector and in the fluid communication with the main combustion chamber. The methanol tank is fluidly connected to a first set of one or more orifices of the dual fuel injector. The second fuel tank is fluidly connected to a second set of one or more orifices of the dual fuel injector supplying the second fuel.

A method includes feeding a first methanol stream to a dual fuel injector as a first fuel. The method further includes reforming a second methanol stream in an onboard methanol reformer, producing a reformer effluent stream. The reformer effluent stream is supplied to the dual fuel injector of a methanol-fueled engine as a second fuel. The first fuel and the second fuel are combusted in a main combustion chamber of the methanol-fueled engine. The method further includes feeding a first methanol stream to a dual fuel injector as a first fuel. An exhaust gas methanol stream is supplied to the dual fuel injector of a methanol-fueled engine as a second fuel. The first fuel and the second fuel are combusted in a main combustion chamber of the methanol-fueled engine.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIGS. 1A and 1B depict onboard and exhaust gas reforming to Dimethyl ether (DME) in accordance with one or more embodiments of the present disclosure.

FIGS. 2A and 2B depict onboard and exhaust gas reforming to Oxymethylene ether (OME) in accordance with one or more embodiments of the present disclosure.

FIGS. 3A and 3B depict onboard and exhaust gas reforming to ethylene in accordance with one or more embodiments of the present disclosure.

FIGS. 4A and 4B depict onboard and exhaust gas reforming to hydrogen in accordance with one or more embodiments of the present disclosure.

FIGS. 5A and 5B depict onboard and exhaust gas reforming to aromatics in accordance with one or more embodiments of the present disclosure.

FIG. 6A depicts dual fuel injection with 10% diesel pilot injection in accordance with one or more embodiments of the present disclosure.

FIG. 6B depicts comparison of in-cylinder pressure between 100% methanol and methanol with diesel as pilot fuel in accordance with one or more embodiments of the present disclosure.

FIG. 7A depicts thermal efficiency of various diesel pilot fractions in accordance with one or more embodiments of the present disclosure.

FIG. 7B depicts in cylinder pressure comparison between diesel and DME as pilot fuel in accordance with one or more embodiments of the present disclosure.

FIG. 8A depicts heat release rate comparison between diesel and DME as pilot fuel in accordance with one or more embodiments of the present disclosure.

FIG. 8B depicts thermal efficiency of various SOI between diesel and DME as pilot fuel in accordance with one or more embodiments of the present disclosure.

FIG. 9 depicts comparison of spray evolution of various SOI between diesel and DME as pilot fuel in accordance with one or more embodiments of the present disclosure.

FIG. 10 is a flow diagram of an onboard reforming process in accordance with one or more embodiments of the present disclosure.

FIG. 11 is a flow diagram of an exhaust gas reforming process in accordance with one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “palette” may include any number of “palettes” without limitation. Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In terms of combustion modes, multiple combustion modes may be used in embodiments disclosed herein. For example, Dimethyl ether (DME), Oxymethylene ether (OME), or ethylene are supplied into the dual fuel injector under compression ignition (CI) mode of operation to replace diesel as pilot fuel. On the other hand, hydrogen or aromatics are supplied into the dual fuel injector under spark ignition (SI) mode of operation to improve ignition and combustion. While described herein with respect to discrete combustion modes, it should be understood that various combustion modes may be used based on fuel type and operation.

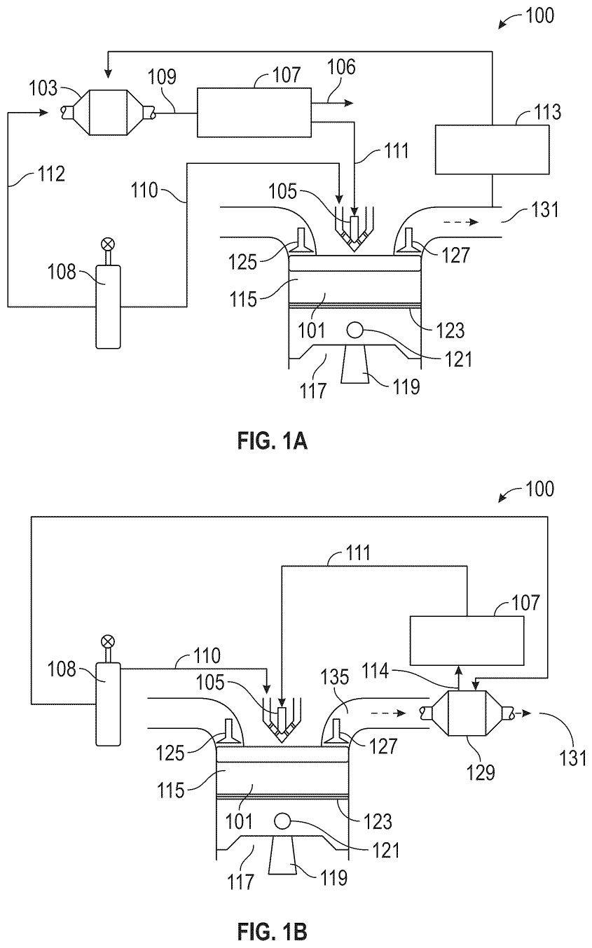

In one aspect, embodiments disclosed herein relate to a methanol marine engine operation using a dual fuel injector. FIG. 1A illustrates an onboard methanol reforming process of the marine engine system 100. The marine engine system 100 includes a marine engine 101, a dual fuel injector 105, and a methanol tank 108. The marine engine 101 includes an intake valve 125, a cylinder head 115, a cylinder 117, a piston rod 119, a piston 121, a main combustion chamber 123, and an exhaust valve 127. Suitable types of marine engines 101 may include outboard, inboard, sterndrive, and jet drive engines. The particular structure and type of the marine engine is not intended to limit the functionality of the marine engine system 100 as described herein.

The dual fuel injector 105 is positioned centrally on the cylinder head 115 and is in fluid communication with the main combustion chamber 123 of the marine engine 101. Additionally, the dual fuel injector 105 has a first set of nozzles for injecting methanol and a second set of nozzles for injecting a Dimethyl ether (DME) stream 109. In the context of this disclosure, the term “dual fuel injector” refers to an injector as part of the marine engine system 100 to inject both methanol stream and second fuel stream (such as Dimethyl ether (DME), Oxymethylene ether (OME), Ethylene (C2), hydrogen, and aromatics) into the cylinder 117 with separate fuel galleries and metering controls for each fuel. Conventionally, marine engines use diesel as a pilot fuel for combustion of methanol. By replacing diesel with DME as pilot fuel, 100% use of carbon neutral fuel may be achieved.

In terms of fuel injection systems, a “port injection” system injects fuel into an intake manifold upstream of a main combustion chamber, and a “direct injection” system sprays or injects fuel directly into the main combustion chamber. While embodiments disclosed herein generally relate to direct injection systems, port injection systems are also contemplated. The dual fuel injector 105 sprays fuels directly into the main combustion chamber 123 of the marine engine 101. Both methanol and second fuels are injected directly into the main combustion chamber 123 via the dual fuel injector 105 at different injection rates. By controlling the mixture, the dual fuel injector 105 leads to better combustion and fuel economy. To inject the fuels directly into the main combustion chamber 123, the dual fuel injector 105 uses high-pressure pumps to operate.

As illustrated in FIG. 1A, a process of reforming methanol to the DME begins with feeding a first methanol stream 110 to the dual fuel injector 105 as a first fuel. A second methanol stream 112 is reformed in an onboard methanol reformer 103, producing a reformer effluent stream including a DME stream 109. Then, a selective membrane 107 separates the reformer effluent stream into a retentate stream 106 and a pure DME stream 111. The pure DME stream 111 is supplied to the dual fuel injector 105 of a methanol-fueled engine as a second fuel. The first methanol stream 110 and the pure DME stream 111 are combusted in the main combustion chamber 123 of the methanol-fueled engine.

Now referring to FIG. 1B, FIG. 1B illustrates a process of exhaust gas reforming to the DME. The process begins with feeding the first methanol stream 110 to the dual fuel injector 105 as a first fuel. An exhaust gas methanol stream 135 is reformed in an exhaust gas methanol reformer 129, producing an exhaust gas reformer effluent. The raw DME stream 114 is supplied to a selective membrane 107 which separates the exhaust gas reformer effluent stream into a retentate stream and the pure DME stream 111. The pure DME stream 111 is then supplied to the dual fuel injector 105 of the marine engine 101 as a second fuel. The first fuel and the second fuel are combusted in the main combustion chamber 123 of the marine engine 101.

For both onboard and exhaust gas fuel reforming processes as illustrated in FIGS. 1A and 1B, the selective membrane 107 is used to separate and supply pure DME to the dual fuel injector 105. Furthermore, the use of the selective membrane 107 increases conversion efficiency of the DME with higher cetane number compared to diesel. At an outlet of the selective membrane, the DME is generated at an injection pressure ranging from 100 bar to 300 bar to keep the DME in liquid state.

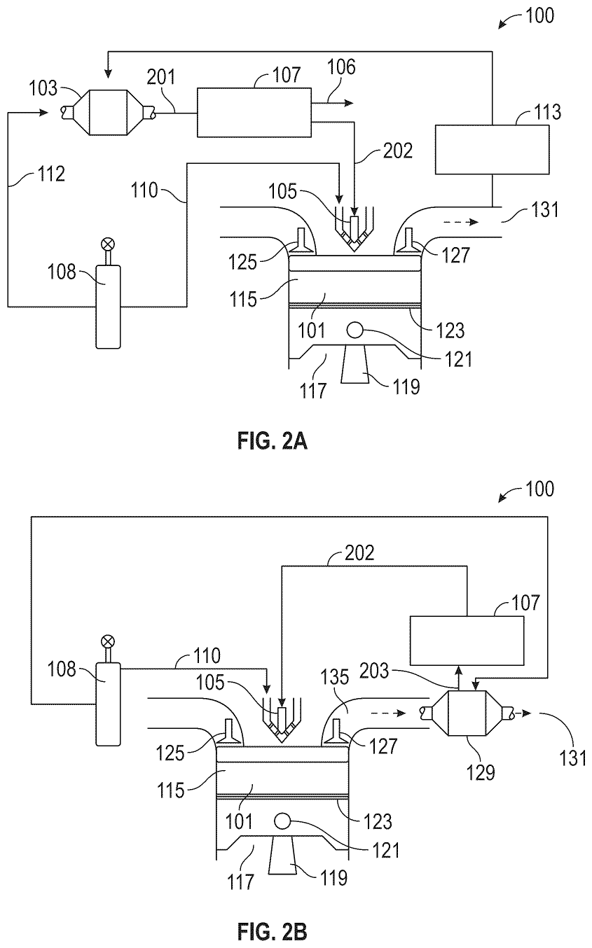

Turning to FIG. 2A, embodiments disclosed herein relate to a process of reforming methanol to Oxymethylene ether (OME). FIG. 2A illustrates the process of reforming methanol to the OME as a second fuel. The process begins with feeding the first methanol stream 110 to the dual fuel injector 105 as a first fuel. As discussed above, the marine engine system 100 includes the marine engine 101, the dual fuel injector 105, and the methanol tank 108. The marine engine 101 includes the intake valve 125, the cylinder head 115, the cylinder 117, the piston rod 119, the piston 121, the main combustion chamber 123, and the exhaust valve 127. The process of reforming methanol to the OME begins with feeding the first methanol stream 110 to the dual fuel injector 105 as a first fuel. A second methanol stream 112 is reformed in the onboard methanol reformer 103, producing a reformer effluent stream including an OME stream 201. Then, a selective membrane 107 separates the reformer effluent stream into a retentate stream 106 and a pure OME stream 202. The pure OME stream 202 is supplied to the dual fuel injector 105 of the methanol-fueled engine as a second fuel. The first methanol stream 110 and the pure OME stream 202 are combusted in the main combustion chamber 123 of the methanol-fueled engine.

The dual fuel injector 105 is positioned centrally on the cylinder head 115 and is in fluid communication with the main combustion chamber 123 of the marine engine 101. Additionally, the dual fuel injector 105 has a first set of nozzles for injecting methanol and a second set of nozzles for injecting the OME stream 201. In the context of this application, the term “dual fuel injector” refers to the marine engine system 100 to inject both the first fuel and the second fuel into the cylinder 117 with separate fuel galleries and metering controls for each fuel.

In one aspect, embodiments disclosed herein relate to a process for exhaust gas methanol reforming to the OME. As discussed above, the marine engine system 100 of FIG. 2B includes the marine engine 101, the dual fuel injector 105, and the methanol tank 108. The marine engine 101 includes the intake valve 125, the cylinder head 115, the cylinder 117, the piston rod 119, the piston 121, the main combustion chamber 123, and the exhaust valve 127. Specifically, FIG. 2B illustrates a process of exhaust gas reforming to the OME. The process begins with feeding the first methanol stream 110 to the dual fuel injector 105 as a first fuel. An exhaust gas methanol stream 135 is reformed in an exhaust gas methanol reformer 129, producing an exhaust gas reformer effluent. The raw OME stream 203 is supplied to a selective membrane 107 which separates the exhaust gas reformer effluent stream into the retentate stream 106 and the pure OME stream 202. The pure OME stream 202 is then supplied to the dual fuel injector 105 of the marine engine 101 as a second fuel. The first fuel and the second fuel are combusted in the main combustion chamber 123 of the marine engine 101.

The characteristics of the OME make the OME suitable fuel for methanol compared to diesel. The OME with 3 to 5 carbons has cetane number between 65 and 90 under compression ignition (CI) mode of operation. Furthermore, the OME is easy to store in liquid form under atmospheric conditions. The OME can be produced onboard through one-step selective oxidation of methanol over a bi-functional catalyst combining acidic and redox properties. In a two-step process, OME can be produced by dehydrogenation of methanol over Ag catalysts to produce a mixture of formaldehyde, methanol and water followed by liquid-phase, acid-catalyzed condensation of methanol and formaldehyde. Formaldehyde is produced through methanoloxy-dehydrogenataion process, which is used to produce tri-oxane (TRI) or paraformaldehyde (PF).

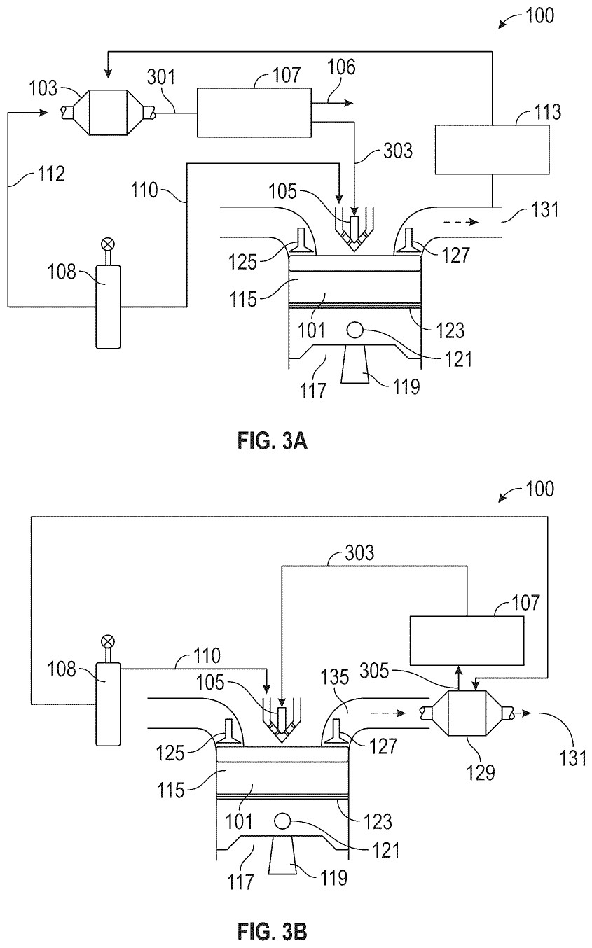

In one aspect, embodiments disclosed herein relate to a process for onboard methanol reforming. FIG. 3A illustrates a process of reforming methanol to ethylene. As discussed above, the marine engine system 100 the marine engine 101, the dual fuel injector 105, and the methanol tank 108. The marine engine 101 includes the intake valve 125, the cylinder head 115, the cylinder 117, the piston rod 119, the piston 121, the main combustion chamber 123, and the exhaust valve 127. The process of reforming methanol to ethylene begins with feeding the first methanol stream 110 to the dual fuel injector 105 as a first fuel. A second methanol stream 112 is reformed in the onboard methanol reformer 103, producing a reformer effluent stream including an ethylene stream 301. Then, a selective membrane 107 separates the reformer effluent stream into a retentate stream 106 and a pure ethylene stream 303. The pure ethylene stream 303 is supplied to the dual fuel injector 105 of the methanol-fueled engine as a second fuel. The first methanol stream 110 and the pure ethylene stream 303 are combusted in the main combustion chamber 123 of the methanol-fueled engine.

Referring now to FIG. 3B, FIG. 3B illustrates a process of exhaust gas methanol reforming to ethylene. The process begins with feeding the first methanol stream 110 to the dual fuel injector 105 as a first fuel. An exhaust gas methanol stream 135 is reformed in an exhaust gas methanol reformer 129, producing an exhaust gas reformer effluent. The raw ethylene stream 305 is supplied to a selective membrane 107 which separates the exhaust gas reformer effluent stream into the retentate stream 106 and the pure ethylene stream 303. The pure ethylene stream 303 is then supplied to the dual fuel injector 105 of the marine engine 101 as a second fuel. The first fuel and the second fuel are combusted in the main combustion chamber 123 of the marine engine 101.

The characteristic of ethylene improves the combustion stability under compression ignition (CI) mode of operation. The reactive ethylene species reduces the ignition delay and combustion duration. In current methanol-to-olefin (MTO) processes, limited selection of a specific olefin is difficult to achieve. In chemistry, olefins are a class of hydrocarbons made up of hydrogen and carbon with one or more pairs of carbon atoms linked by a double bond. The bifunctional catalyst composed of selectively dealuminated H-MOR zeolite and ZnO—TiO2, which implemented methanol carbonylation with CO to acetic acid and selective acetic acid hydrogenation to ethylene in tandem, offers ethylene selectivity of 85%. Using the selective membrane 107 with the onboard methanol reformer 103 separates and supplies pure ethylene to the dual fuel injector 105. The use of the selective membrane 107 with the reformer 103 ensures better conversion efficiency of methanol to reactive ethylene.

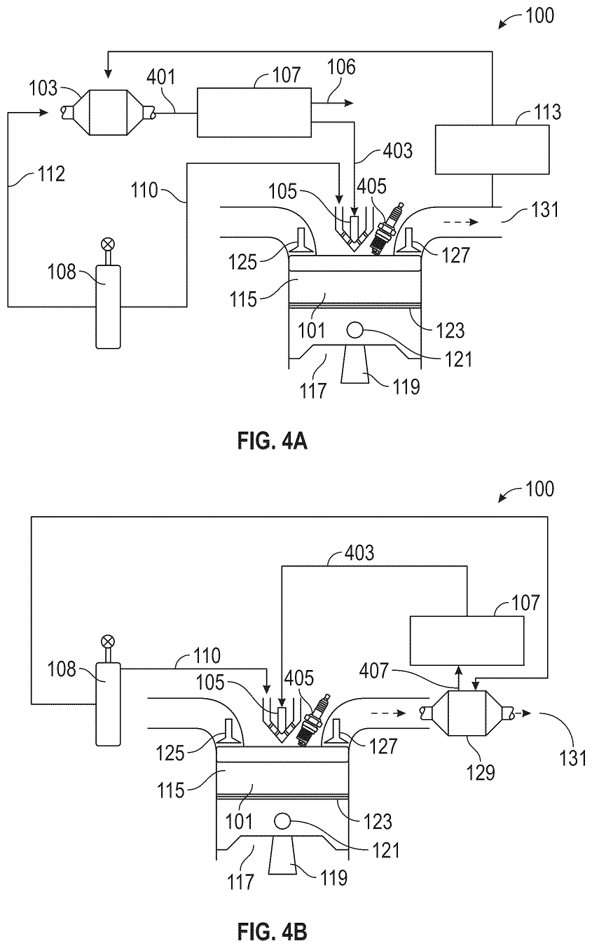

In one aspect, embodiments disclosed herein relate to a process for onboard methanol reforming to hydrogen. FIG. 4A illustrates a process of reforming methanol to hydrogen. As discussed above, the marine engine system 100 the marine engine 101, the dual fuel injector 105, a spark plug 405, and the methanol tank 108 supplying the first methanol stream 110 to the dual fuel injector 105. The marine engine 101 includes the intake valve 125, the cylinder head 115, the cylinder 117, the piston rod 119, the piston 121, the main combustion chamber 123, and the exhaust valve 127. A methanol steam reforming (MSR) system is configured to produce a hydrogen stream 401 where the hydrogen stream 401 is supplied to the dual fuel injector 105. The process of the methanol steam reforming system begins with feeding the first methanol stream 110 to the dual fuel injector 105 as a first fuel. A second methanol stream 112 is reformed in the onboard methanol reformer 103, producing a reformer effluent stream including a hydrogen stream 401. Then, a selective membrane 107 separates the reformer effluent stream into a retentate stream 106 and a pure hydrogen stream 403. The pure hydrogen stream 403 is supplied to the dual fuel injector 105 of the methanol-fueled engine as a second fuel. The first methanol stream 110 and the pure hydrogen stream 403 are combusted in the main combustion chamber 123 of the methanol-fueled engine.

In another aspect, embodiments disclosed herein relate to a process for exhaust gas methanol reforming to hydrogen. FIG. 4B illustrates a process of exhaust gas methanol reforming to hydrogen. Water gas shift (WSG) or methanol decomposition (MD) systems are configured to produce hydrogen by reforming an exhaust gas stream in a selective membrane 107. The first methanol stream 110 is fed to the dual fuel injector 105 as a first fuel. An exhaust gas methanol reformer 129 reforms an exhaust gas methanol stream and produces an exhaust gas reformer effluent stream. The selective membrane 107 then separates the exhaust gas reformer effluent stream into a retentate stream 106 and the pure hydrogen stream 403. The pure hydrogen stream 403 is supplied to the dual fuel injector 105 as a second fuel. The first fuel and the second fuel are combusted in a main combustion chamber 123 of the marine engine 101.

Hydrogen is supplemented or added to improve flame propagation and combustion. Hydrogen can be generated onboard through direct methanol steam reforming (MSR), water gas shift (WSG) reaction, or methanol decomposition (MD) into hydrogen. Onboard reforming of methanol into hydrogen is supplied through the dual fuel injector 105 with the spark plug 405 that is placed adjacent to the centrally mounted dual fuel injector 105.
MSR: CH3OH+H2O↔CO2+3H2 ΔH298 K=+49.4 kJ/mol
WGS: CO+H2O↔CO2+H2 ΔH298 K=−41.1 kJ/mol
MD: CH3OH→CO+2H2 ΔH298 K=+92.0 kJ/mol

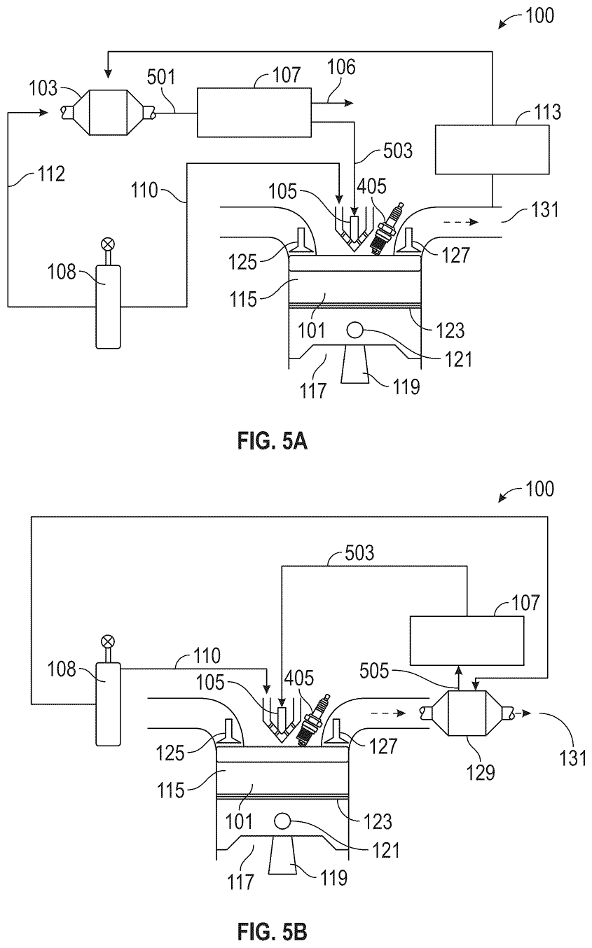

In one aspect, embodiments disclosed herein relate to a process for onboard methanol reforming to aromatics. FIG. 5A illustrates a process of reforming methanol to aromatics. Aromatics are a type of fuel that comprises of benzene, toluene, xylenes, and C9 aromatics. For example, aromatics are added to gasoline to increase octane rating. The higher the octane rating, know resistance improves, which advances spark timing for attaining maximum torque. The maximum torque represents the engine's ability to produce the most rotational force. In other words, it measures engine performance. As a result, reforming methanol to aromatics onboard improves engine performance.

Specifically, FIG. 5A illustrates a process of reforming methanol to aromatics. The process begins with feeding the first methanol stream 110 to the dual fuel injector 105 as a first fuel. A second methanol stream 112 is reformed in the onboard methanol reformer 103, producing a reformer effluent stream including an aromatics stream 501. Then, a selective membrane 107 separates the reformer effluent stream into a retentate stream 106 and a pure aromatics stream 503. The pure aromatics stream 503 is supplied to the dual fuel injector 105 of the methanol-fueled engine as a second fuel. The first methanol stream 110 and the pure aromatics stream 503 are combusted in the main combustion chamber 123 of the methanol-fueled engine.

In another aspect, embodiments disclosed herein relate to a process for exhaust gas methanol reforming to hydrogen. FIG. 5B illustrates a process of exhaust gas methanol reforming to aromatics. The process begins with feeding the first methanol stream 110 to the dual fuel injector 105 as a first fuel. An exhaust gas methanol stream 135 is reformed in an exhaust gas methanol reformer 129, producing an exhaust gas reformer effluent. The raw aromatics stream 407 is supplied to a selective membrane 107 which separates the exhaust gas reformer effluent stream into the retentate stream 106 and the pure aromatics stream 505. The pure aromatics stream 503 is then supplied to the dual fuel injector 105 of the marine engine 101 as a second fuel. The first fuel and the second fuel are combusted in the main combustion chamber 123 of the marine engine 101.

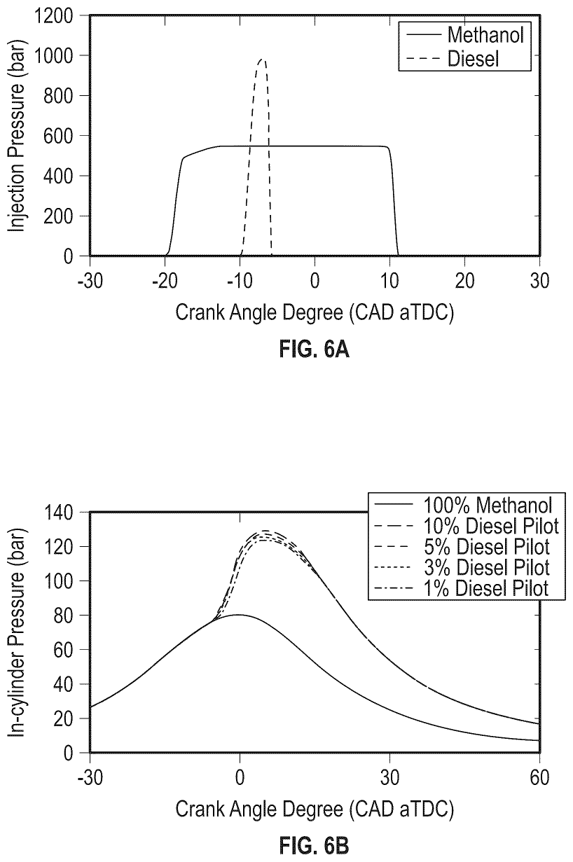

Turning now to FIGS. 6A-8B, these figures illustrate various aspects of one or more embodiments of the disclosure. FIG. 6A illustrates a graph of dual fuel injection with 10% diesel pilot fuel. Methanol and DME were injected at injection pressure of 600 bar, and diesel was injected at injection pressure of 1000 bar. Horizontal axis represents crank angle degree, and vertical axis represents injection pressure in bar. Turning to FIG. 6B, FIG. 6B illustrates a graph of in-cylinder pressure by varying amount of diesel pilot fuel. 100% of methanol was injected, and the amount of diesel injection varied (1%, 3%, 5%, 10%, and 100%). Similarly, horizontal axis represents crank angle degree, and vertical axis represents injection pressure in bar.

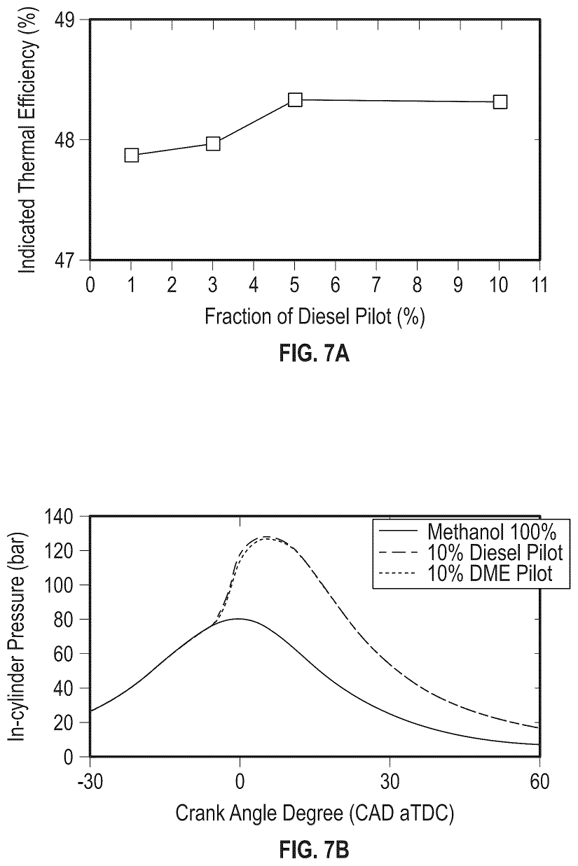

Turning to FIG. 7A, FIG. 7A illustrates a graph of indicated thermal efficiency varying fractions of diesel pilot fuel. The graph shows that a minimum of 5% diesel pilot fuel is necessary for better engine thermal efficiency. 10% diesel pilot fuel injector was selected for robust combustion in various conditions with different fuels. FIG. 7B illustrates a graph of comparison between 10% diesel injection and 10% DME pilot injection. FIG. 7B shows that the injection of DME increases pressure faster than pure methanol combustion.

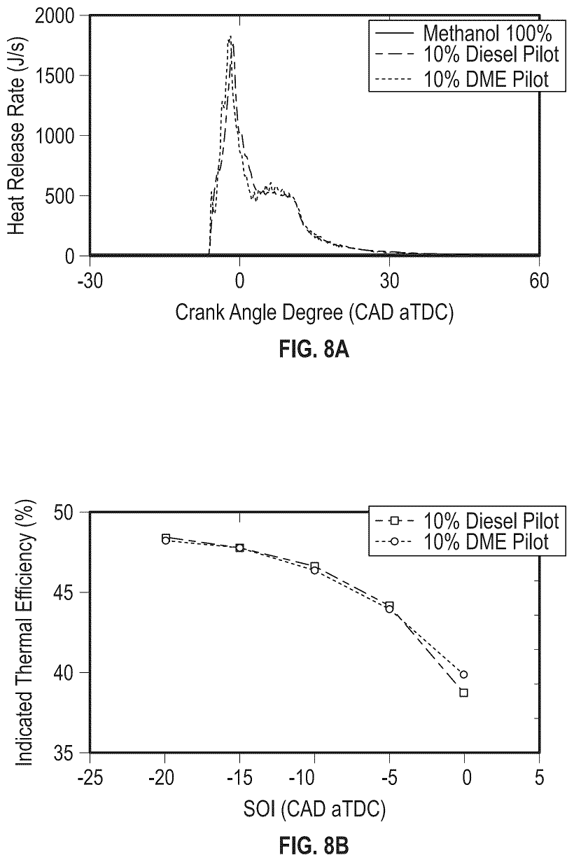

Turning to FIG. 8A, FIG. 8A illustrates a graph of heat release rate with 100% methanol injection, 10% diesel injection, and 10% DME injection. FIG. 8A shows that the injection of DME performs better than the injection of diesel under the same condition. This means that diesel can be replaced by DME, and onboard methanol reforming may not require additional fuel storage for diesel. In addition to the thermal efficiency test, multiple SOIs were tested and compared as illustrated in FIG. 8B. FIG. 8B shows that the thermal efficiency of the DME injection performs better than the thermal efficiency of the diesel injection. Due to ignition properties of DME, DME may perform better at late injection and low load condition. This may provide a wider range of engine operation conditions and more flexibility.

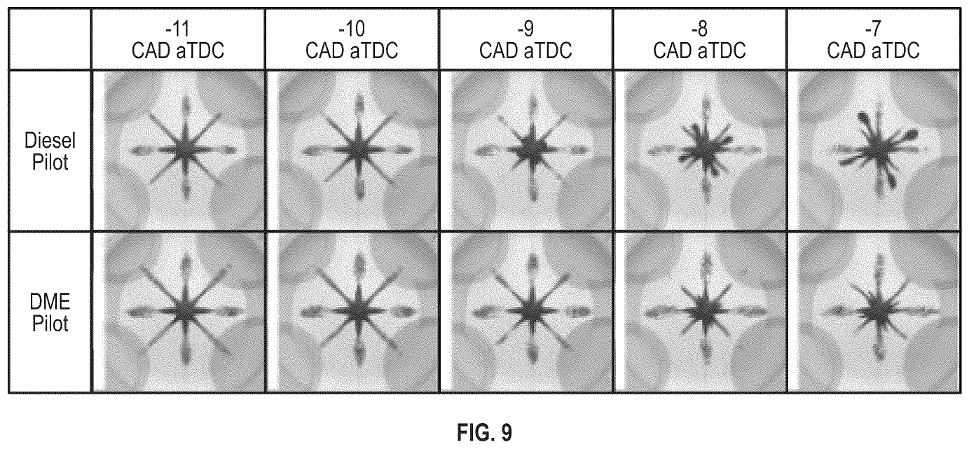

Turning to FIG. 9, FIG. 9 illustrates a spray evolution for diesel and DME injections. Diesel has higher viscosity, surface tension, and boiling point, which leads to late spray evaporation and increased penetration with larger momentum of fuel spray and droplet by higher injection pressure. Despite different properties of DME and diesel, both pilot fuels showed comparable performance. Using a dual fuel injector under high injection pressure should not significantly affect fuel ignitability and combustion despite the different properties of DME and diesel. This shows that the DME can be used as pilot fuel, instead of diesel.

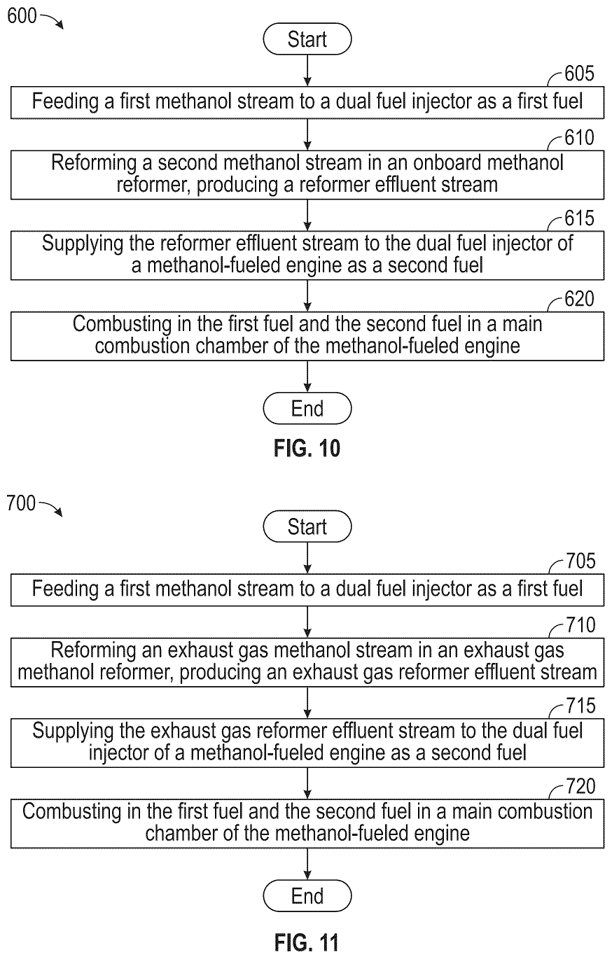

FIG. 10 is a flow diagram of a method 1000 in accordance with one or more embodiments. In step 1005, a first methanol stream 110 is fed to a dual fuel injector 105 as a first fuel.

In step 1010, a second methanol stream 112 is reformed in an onboard methanol reformer 103, producing a reformer effluent stream. In step 1015, the reformer effluent stream is supplied to the dual fuel injector 105 of a marine engine 101 as a second fuel. In step 1020, the first fuel and the second fuel are combusted in a main combustion chamber 123 of the marine engine 101.

FIG. 11 is a flow diagram of a method 1100 in accordance with one or more embodiments. In step 1105, a first methanol stream 110 is fed to a dual fuel injector 105 as a first fuel. In step 7110, an exhaust gas methanol stream 135 is reformed in an exhaust gas methanol reformer 129, producing an exhaust gas reformer effluent stream. In step 1115, the exhaust gas reformer effluent stream is supplied to the dual fuel injector 105 of a methanol-fueled engine as a second fuel. In step 1120, the first fuel and the second fuel are combusted in a main combustion chamber 123 of the marine engine 101.

Embodiments of the present disclosure may provide at least one of the following advantages. The use of methanol in marine engines significantly reduces Green House Gas (GHG) emissions, improves engine performance, and reduces emissions during combustion. Furthermore, reforming methanol onboard to generate ignition sources such as DME, OME, and ethylene reduces complexity of carrying two different fuels in two separate fuel tanks.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A system for combustion comprising:
a dual fuel injector disposed centrally on a cylinder head and in fluid communication with a main combustion chamber of a marine engine, wherein the dual fuel injector has a first set of one or more nozzles for injecting a methanol stream and a second set of one or more nozzles for injecting a second fuel;
a spark plug disposed adjacent to the dual fuel injector and in the fluid communication with the main combustion chamber;
a methanol tank fluidly connected to a first set of one or more orifices of the dual fuel injector; and
a second fuel tank fluidly connected to a second set of one or more orifices of the dual fuel injector supplying the second fuel.

2. The system of claim 1, further comprising:
wherein the second fuel is Dimethyl ether (DME).

3. The system of claim 2, further comprising:
an onboard methanol reformer which reforms a second methanol stream and produces the DME as a reformer effluent stream operating under compression ignition (CI) mode.

4. The system of claim 3, further comprising:
a selective membrane which receives the reformer effluent stream and separates the reformer effluent stream into a retentate stream and a pure DME stream, wherein the pure DME stream is fed to the dual fuel injector as the second fuel.

5. The system of claim 1, further comprising:
wherein the second fuel is Oxymethylene ether (OME).

6. The system of claim 5, further comprising:
an onboard methanol reformer which reforms a second methanol stream and produces the OME as a reformer effluent stream operating under compression ignition (CI) mode.

7. The system of claim 6, further comprising:
a selective membrane which receives the reformer effluent stream and separates the reformer effluent stream into a retentate stream and a pure OME stream, wherein the pure OME stream is fed to the dual fuel injector as the second fuel.

8. The system of claim 1, further comprising:
wherein the second fuel is ethylene.

9. The system of claim 8, further comprising:
an onboard methanol reformer which reforms a second methanol stream and produces ethylene as a reformer effluent stream operating under compression ignition (CI) mode.

10. The system of claim 9, further comprising:
a selective membrane which receives the reformer effluent stream and separates the
reformer effluent stream into a retentate stream and a pure ethylene stream, wherein the pure ethylene stream is fed to the dual fuel injector as the second fuel.

11. The system of claim 1, further comprising:
wherein the second fuel is hydrogen.

12. The system of claim 11, further comprising:
a methanol steam reforming (MSR) system configured to produce a hydrogen stream where
the hydrogen stream is supplied to the dual fuel injector operating under spark ignition (SI) mode.

13. The system of claim 12, further comprising:
water gas shift (WSG) or methanol decomposition (MD) systems configured to produce
hydrogen by reforming an exhaust gas stream in a selective membrane operating under spark ignition (SI) mode.

14. The system of claim 1, further comprising:
wherein the second fuel is a mixture of one or more aromatics selected from the group consisting of benzene, toluene, xylenes, and one or more C9 aromatics.

15. The system of claim 14, further comprising:
an onboard methanol reformer which reforms a second methanol stream and produces aromatics as a reformer effluent stream operating under spark ignition (SI) mode.

16. The system of claim 15, further comprising:
a selective membrane which receives the reformer effluent stream and separates the reformer effluent stream into a retentate stream and a pure aromatic stream, wherein the pure aromatic stream is fed to the dual fuel injector as the second fuel.

17. A process of reforming and combusting methanol, the process comprising:
feeding a first methanol stream to a dual fuel injector as a first fuel;
reforming a second methanol stream in an onboard methanol reformer, producing a reformer effluent stream;
supplying the reformer effluent stream to the dual fuel injector of a methanol-fueled engine as a second fuel; and
combusting in the first fuel and the second fuel in a main combustion chamber of the methanol-fueled engine.

18. The process of claim 17, further comprising separating the reformer effluent stream into a retentate stream and a pure second fuel stream using a selective membrane and supplying the pure second fuel stream into the dual fuel injector as the second fuel.

19. A process of operating a marine internal combustion engine, comprising:
feeding a first methanol stream to a dual fuel injector as a first fuel;
reforming an exhaust gas methanol stream in an exhaust gas methanol reformer, producing an exhaust gas reformer effluent stream;
supplying the exhaust gas reformer effluent stream to the dual fuel injector of a methanol-fueled engine as a second fuel; and
combusting in the first fuel and the second fuel in a main combustion chamber of the methanol-fueled engine.

20. The process of claim 19, further comprising separating the exhaust gas reformer effluent stream into a retentate stream and a pure second fuel stream using a selective membrane and supplying the pure second fuel stream into the dual fuel injector as the second fuel.
